(19) United States
(12) Patent Application Publication
(10) Pub. No.: US 2013/0269468 A1
(43) Pub. Date: Oct. 17, 2013

(54) Height-Adjustable Safety Steering Column Assembly

(71) Applicants: Christian Ehlers, Hamburg (DE); Holger Kittler, Hamburg (DE); Thomas Krueger, Buchholz i.d.N. (DE); Marco Schwieger, Hamburg (DE)

(72) Inventors: Christian Ehlers, Hamburg (DE); Holger Kittler, Hamburg (DE); Thomas Krueger, Buchholz i.d.N. (DE); Marco Schwieger, Hamburg (DE)

(73) Assignee: Daimler AG, Stuttgart (DE)

(21) Appl. No.: 13/884,783

(22) PCT Filed: Oct. 18, 2011
(86) PCT No.: PCT/EP2011/005241

§ 371 Date: Jun. 27, 2013

(30) Foreign Application Priority Data
Nov. 11, 2010 (DE) 102010051039.4

(51) Int. Cl. B62D 1/18

(52) U.S. Cl. CPC B62D 1/18
USPC 74/493

(57) ABSTRACT

A height-adjustable safety steering column assembly includes a console installed securely on the vehicle and in which an outer jacket tube is pivotably mounted. The outer jacket tube comprising includes a steering spindle having a universal joint and an inner jacket tube, which surrounds a telescoping steering wheel-side section of the steering spindle. The pivotable connection of the outer jacket tube with the console installed securely on the vehicle is implemented by two riveted joints provided diametrically on a circumference of the jacket tube and which form a rotation axis corresponding to the universal joint axis of the steering spindle. For each of the connections formed by two rivets, the console installed securely on the vehicle has a passage leading into a passage of the outer jacket tube. A rivet closing head is seated on the jacket tube side.

The invention relates to a height-adjustable safety steering column assembly.

In prior art height-adjustable safety steering column assemblies with a console installed securely on the vehicle, the jacket tube can be pivotably mounted on the console. The steering spindle with a universal joint and generally an inner jacket tube with a telescoping, steering wheel-side section of the steering spindle are mounted in the jacket tube. In height-adjustable safety steering columns, the adjustment system, which comprises the jacket tube pivotably mounted on the console, must be mounted by means of a rotation axis. Positioning tolerances may arise during the assembly of the steering column with a console, which console forms the pivot axis and is connected to a vehicle structure. These tolerances must be compensated in order to configure a connection that is rigid and free of play and thus safe.

In order to achieve an exact positioning of the two components relative to one another with as little play as possible, the components to be joined (i.e., the console and the jacket tube) must be manufactured with low tolerances in the joint region. Manufacturing by casting makes this expensive and makes subsequent machining of the components necessary. To date play is still barely compensable.

DE 10 2009 052 355 A1 discloses a positioning device for the play-free fixing of an axis element, which is pivotable about another element, for a steering column support. An element is pivotably assembled around the axis element by connecting it to a bearing bushing traversed by said axis element. The cut-out in the support section is an oblong hole with a height and width that are greater than a diameter of the axis element, thus allowing said axis element to be positioned in a plane perpendicular to itself. The axis element can be a threaded shaft on which is arranged a spreadable clamping element, which engages with an inner wall of the oblong hole. A play-free fastening of the positioning device is achieved by the spread-apart clamping element, which clamps with the inner wall of the oblong hole after the shaft of the pivot axis provided for the element has been at least positioned in the oblong hole of the support section. The clamping element thus used permits the components to be borne (i.e., the pivot element and the support section) to be manufactured with casting tolerances in the joint region, hence subsequent machining is no longer necessary.

DE 10 2004 020 048 A1 also discloses a safety steering column for a motor vehicle, which steering column consists of a telescoping steering spindle with an upper spindle section near the steering wheel and a lower spindle section remote from the steering wheel and which is rotatably mounted in a jacket tube. The jacket tube is configured in multiple parts and is telescoping. The tube parts are mounted on a console installed securely on the vehicle (on-board console), wherein no further explanation of the attachment is given.

DE 29 501 552.7 discloses another steering column attachment for motor vehicles, which has a deformation element as a safety element. Said element is provided between a steering console and a steering column jacket tube traversed by a steering column. The deformation element can be fastened to the shank of the steering console by means of, say, rivets. The steering device disclosed therein is neither height-adjustable nor telescoping.

This prior art gives rise to the objective of creating a height-adjustable safety steering column assembly in which, in order to achieve a high rigidity and natural frequency of the steering column, the rotation axis is attached as securely as possible on the one hand, yet mounted so that it is easily movable for ergonomic adjustability on the other. It should also be possible to compensate for assembly tolerances between the on-board console and the jacket tube. The solution for doing so should be achievable in a simple, economic, and reliable manner.

This objective is achieved by a height-adjustable safety steering column assembly with the features of claim 1.

Improvements of the device are the subject of the subordinate claims.

A first embodiment of the height-adjustable safety steering column assembly has an on-board console, in which is pivotably mounted an outer jacket tube comprising a steering spindle with a universal joint and further comprising an inner jacket tube, which surrounds a telescoping steering wheel-side section of the steering spindle. The pivotable connection of the outer jacket tube to the on-board console is achieved by means of two riveted joints disposed diametrically on the circumference of the jacket tube and advantageously forming a rotation axis, which corresponds to the universal joint axis of the steering spindle. A kinematic displacement in the steering spindle is thus prevented.

For each of the joints formed by two rivets, the on-board console has a passage that leads to a corresponding passage of the outer jacket tube. In each case the rivet head is seated on the jacket tube side. The rotation axis formed by the riveted joints is advantageously configured such that any assembly tolerances between the on-board console and the outer jacket tube can be compensated.

The rivet, which has a rivet setting head and a rivet shaft, is disposed such that the rivet closing head produced in closing the riveted joint is created or closed on the jacket tube side, which is advantageous in terms of assembly.

For receiving the rivet setting head, the passage of the on-board console advantageously has, at least on its side facing away from the jacket tube, a chamfer or a countersink configured so as to correspond to the shape of the rivet setting head. Furthermore, the passage of the outer jacket tube can also have a chamfer or a countersink on its side facing away from the on-board console for receiving the rivet closing head with at least the junction portion between the rivet shaft and the closing head.

The rivets can be standard, industrially produced rivets such as semi-tubular rivets, countersunk rivets, orbital rivets, clinch rivets, wobble rivets, or other suitable simple rivets.

A bushing is advantageously arranged in the passage formed jointly by the jacket tube passage and the console passage. It is advantageous if the bushing for reducing the friction of the rivet-cast component connection extends at least into the portion of the passage that is formed in the jacket tube; however, the bushing can also extend into the adjoining portion of the passage of the on-board console. Such a bushing can advantageously be made of plastic; it surrounds at least the shaft of the rivet.

For better assembly, the bushing can be configured with a flange-shaped edge on the closing head side. Furthermore, this edge can be received at least partly in the countersink or in the chamfer.

Furthermore, the passage of the on-board console in another embodiment also has a chamfer or a countersink on its side facing towards the outer jacket tube, which chamfer or a countersink corresponds to a portion of the bushing extending into the passage of the on-board console, which bushing has a complementary shape corresponding to the passage shape formed.

The bushing can have a conical outer circumference, and the two adjoining passages viewed together would likewise form a complementary cone.

In a special embodiment of the rivet, the latter can have a cylindrical rivet shaft with an outer circumferential shoulder. It thus follows that the rivet is disposed such that a section of the rivet shaft with a larger diameter is seated in the passage of the console, which likewise has a larger diameter, whereas a section with a smaller diameter is seated in the passage of the jacket tube, which correspondingly has a smaller diameter, since the rivet with the unclinched closing head is first inserted into the passage of the console. This riveted joint with an axial shoulder advantageously serves as a stop for a defined gap to be maintained between the jacket tube and the console and which is subsequently used for compensating tolerances.

This riveted joint is thus particularly advantageous for joining jacket tube and console components produced by casting, in which compensation of the aforementioned manufacturing-induced tolerances is often a requirement.

Thus the height-adjustable safety steering column assembly of the invention makes it possible to obtain a steering column with particularly high rigidity and natural frequency, which results in improved safety of the steering system. These advantages are achieved by the positive-locking axial and radial compensation of the play of the riveted joint. Furthermore, the riveted joint permits easy assembly and is economically produced.

These and other advantages will emerge from the following description, which refers to the accompanying figures.

The references to the figures in the description are intended to supplement the description and facilitate the understanding of the subject matter. Objects or parts of objects that are essentially the same or similar may be designated with the same reference signs. The figures are merely a schematic illustration of an embodiment of the invention.

Shown are:

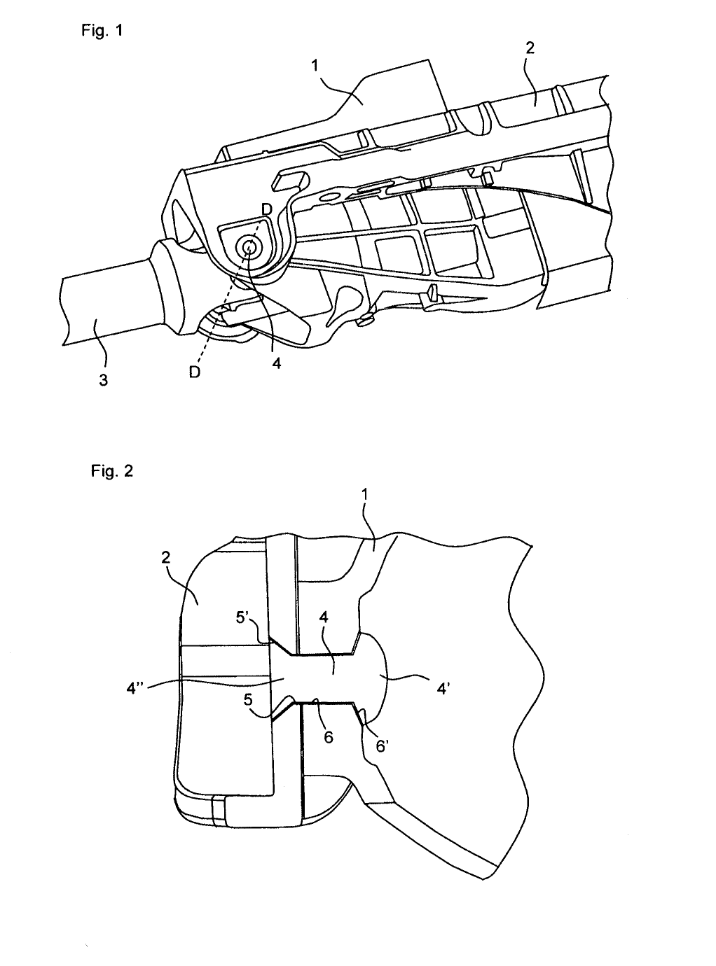

FIG. 1 a perspective lateral view looking onto a portion of a height-adjustable safety steering column assembly of the invention,

FIG. 2 a lateral view of the riveted joint of the invention,

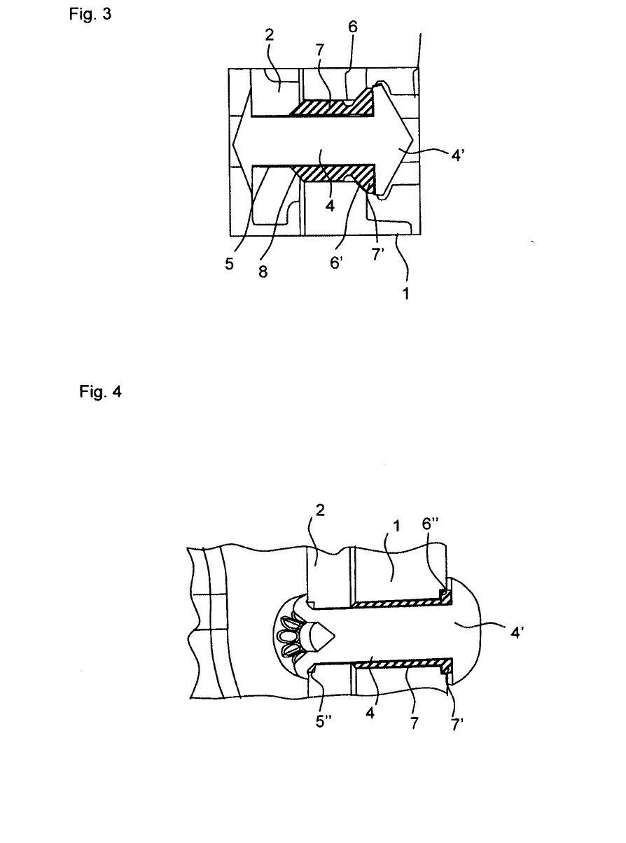

FIG. 3 a lateral view of another embodiment of the riveted joint,

FIG. 4 a lateral view of another embodiment of the riveted joint,

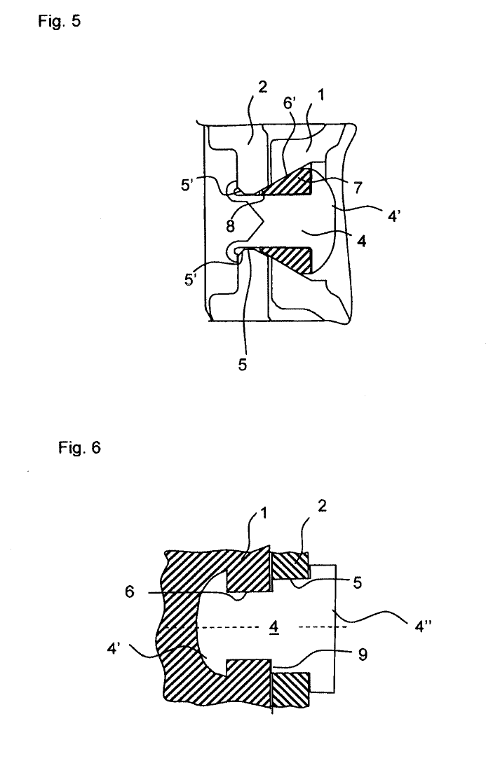

FIG. 5 a lateral view of another embodiment of the riveted joint,

FIG. 6 a lateral view of another embodiment of the riveted joint.

The device of the invention relates to a height-adjustable safety steering column assembly as shown in portions in FIG. 1. An on-board console 2 in which an outer jacket tube 1 is pivotably mounted can be discerned therein. Said outer jacket tube 1 comprises a steering spindle 3 with a universal joint and further comprises an inner jacket tube, which surrounds a telescoping steering wheel-side section of the steering spindle.

The pivotable connection of the outer jacket tube 1 to the on-board console 2 is achieved by means of two riveted joints; only one of the riveted joints with the rivet 4 is visible in FIG. 1. The two riveted joints are provided diametrically on a circumference of the jacket tube 1 and form a rotation axis D-D corresponding to the universal joint axis of the steering spindle 3.

This is achieved by the on-board console 2 having a passage 5 for each joint formed by the two rivets 4 (visible in FIGS. 2 through 6), which adjoins a passage 6 of the jacket tube 1. As can be seen in all FIGS. 2 through 6, the setting head 4″ is positioned on the console side, whereas the closing head 4′ is formed on the jacket tube side.

For receiving the setting head 4″, the passage 5 can have a chamfer 5′, as seen in FIG. 2. If the setting head 4″ has a tapering shape (see FIG. 3), then the latter does not have to be received in the passage 5 of the console 2 but can come into abutment thereon. Depending upon the clinching tool chosen, the closing head 4′ may also taper (see FIG. 3) or it can be configured in the form of a dome (see FIGS. 2, 4, and 5). It is also possible to produce a flat closing head 4′ (see FIG. 6).

The passage 6 of the outer jacket tube 1 can advantageously have a chamfer 6′ on its side facing away from the on-board console 2, as shown in FIG. 2, or it can also be countersunk. Such a countersink 2′ is shown in FIG. 4. As the rivet 4 is deformed, an axial and radial compensation of the play is achieved via the chamfer 6′,5′, which essentially forms a cone in the perforation of the console 2 as well as in the jacket tube 2. A greater rigidity and natural frequency are thus imparted to the steering column assembly.

In order to reduce friction, the passage 5,6 can be advantageously equipped with a bushing 7, at least on the jacket tube side. To this end, use can be made of plastic bushings for improving the sliding friction, which is advantageous in the event of a tight connection or excessive wear of the rivet-cast component joint.

Bushings 7 with different shapes are shown in FIGS. 3 through 6: For the bushing 7 shown in FIG. 5, the passage 5 of the console 2 must also be chamfered on the jacket tube side. The chamfer 8 thus provided complements the conical shape of the passage 6′, thus forming an overall conical passage in which a correspondingly-shaped bushing 7 can be disposed.

In contrast, the bushing 7 shown in the partial perspective view of FIG. 4 is cylindrical, but has on the closing head side a flange 7′, which serves for better positioning and which is received in the countersink 6″ of the jacket tube. The closing head 4′ of the rivet 4 is formed over this arrangement and ensures a secure seating of the cast component-plastic joint.

The bushing 7 in FIG. 3 also has a flange 7′ on the jacket tube side. The shape of this flange, however, is tapered and thus corresponds to the chamfer 6′ on the entry side of the passage 6 of the jacket tube.

If a defined position of the jacket tube 1 and the console 2 needs to be established, suitably shaped rivets 4 having a shoulder can be useful for achieving the desired positioning. Such a suitable rivet shape is shown in FIG. 6. The rivet 4 therein has a cylindrical rivet shaft which, however, has a shoulder 9 on its circumference. When such a rivet 4 is used, the section of the rivet shaft with the smaller diameter seats in the passage 6 of the jacket tube 1, whereas the section with the larger diameter seats in the passage 5 of the console 2, since the rivet 4 is initially inserted therein.

A height-adjustable safety steering column assembly with high natural frequency and rigidity owing to the positive-locking axial and radial compensation of the play provided by the riveted joint of the invention is thus achieved with the device of the invention. The riveted joint is easily and economically produced, and die cast parts having manufacturing-induced assembly tolerances can thus be suitably joined together.

1-9. (canceled)

10. A height-adjustable safety steering column assembly, comprising:
an on-board console securely installed on a vehicle;
an outer jacket tube pivotably mounted in the on-board console, wherein the outer jacket tube comprises a steering spindle with a universal joint and an inner jacket tube surrounding a telescoping steering wheel-side section of the steering spindle,
wherein the outer jacket tube is pivotably mounted in the on-board console via a pivotable connection comprising two riveted joints, wherein the two riveted joints are arranged diametrically on a circumference of the outer jacket tube and form a rotation axis corresponding to the universal joint of the steering spindle, which prevents a kinematic displacement in the steering spindle, and
wherein for each of the joints formed by two rivets, the on-board console has a passage that leads to a passage of the outer jacket tube, and wherein a rivet closing head of each of the two rivets is seated on the outer jacket tube side.

11. The height-adjustable safety steering column assembly as in claim 10, wherein:
the passage of the on-board console has, at least on its side facing away from the outer jacket tube, a chamfer or a countersink configured to receive a rivet setting head; and
the passage of the outer jacket tube has, on its side facing away from the on-board console, a chamfer or a countersink configured to at least partly receive the rivet closing head.

12. The height-adjustable safety steering column assembly as in claim 10, wherein the two rivets are semi-tubular rivets, countersink rivets, orbital rivets, clinch rivets, wobble rivets, or other suitable simple rivets.

13. The height-adjustable safety steering column assembly as in claim 11, further comprising:
a plastic bushing arranged
at least in the passage of the outer jacket tube; or
in the passage of the outer jacket tube and in at least a portion of the passage of the on-board console adjoining the passage of the outer jacket tube,
wherein the plastic bushing surrounds a rivet shaft of the rivet.

14. The height-adjustable safety steering column assembly as in claim 13, wherein the bushing is configured, on the rivet closing head side, with a flange-shaped edge, wherein the flange-shaped edge is at least partly received in the countersink.

15. The height-adjustable safety steering column assembly as in claim 13, wherein the passage of the on-board console has a chamfer or a countersink on its side facing towards the outer jacket tube, and wherein a section of the bushing extending into the passage of the on-board console has a shape that is complementary to the chamfer or countersink.

16. The height-adjustable safety steering column assembly as in claim 15, wherein the bushing has a conical outer circumference, and wherein the passage of the on-board console and the passage of the outer jacket tube each include a complementary cone for receiving the bushing.

17. The height-adjustable safety steering column assembly as in claim 10, wherein the rivet has a cylindrical rivet shaft and has a shoulder on its circumference, wherein a section of the rivet shaft with a larger diameter is configured to a diameter of the passage of the jacket tube and a section with a smaller diameter is configured to a diameter of the passage of the console.

18. The height-adjustable safety steering column assembly as in claim 10, wherein the jacket tube and the on-board console are die cast components.
